(19) United States
(12) Patent Application Publication
(10) Pub. No.: US 2025/0250188 A1
(43) Pub. Date: Aug. 7, 2025

(54) Water Purification Apparatus And Water Purification System

(71) Applicant: SEIKO EPSON CORPORATION, Tokyo (JP)

(72) Inventor: Yohei YAMADA, Chino (JP)

(21) Appl. No.: 19/045,643

(22) Filed: Feb. 5, 2025

(30) Foreign Application Priority Data
Feb. 6, 2024 (JP) 2024-016181

(51) Int. Cl. C02F 3/00; C02F 3/12; C02F 11/00; C02F 11/02; C02F 103/00

(52) U.S. Cl. CPC C02F 3/005; C02F 3/12; C02F 11/006; C02F 11/02; C02F 2103/007; C02F 2201/46105

(57) ABSTRACT

A water purification apparatus includes a container body holding a liquid containing organic substances and electrochemically active bacteria, an anode electrode disposed in the liquid, a hollow body holding a gas containing oxygen, a cathode electrode having a first surface in contact with the liquid and a second surface that allows the oxygen contained in the gas held in the hollow body to permeate, and being disposed with respect to the anode electrode via the liquid, and a resistor electrically coupled to the anode electrode and the cathode electrode.

The present application is based on, and claims priority from JP Application Serial Number 2024-016181, filed Feb. 6, 2024, the disclosure of which is hereby incorporated by reference herein in its entirety.

### BACKGROUND

### 1. Technical Field

The present disclosure relates to a water purification apparatus and a water purification system.

### 2. Related Art

A water purification system for improving quality of water of rivers and lakes is known. JP-A-2016-168560 discloses a bottom sediment improving apparatus as a water purification system. The bottom sediment improving apparatus improves the bottom sediment of a river or the like using the mechanism of a microbial fuel cell (MFC). The bottom sediment improving apparatus improves water quality by removing phosphorus or the like immobilized in the bottom sediment. The bottom sediment improving apparatus includes an anode electrode and a cathode electrode. The cathode electrode causes redox reaction of dissolved oxygen in water. The cathode electrode includes a plurality of carbon felt electrodes provided in positions at different water depths.

JP-A-2016-168560 is an example of the related art.

When the cathode electrode is disposed in a place where the amount of dissolved oxygen is small, the redox reaction in the cathode electrode may be insufficient.

### SUMMARY

A water purification apparatus according to an aspect of the present disclosure includes a container body holding a liquid containing organic substances and electrochemically active bacteria, an anode electrode disposed in the liquid, a hollow body holding a gas containing oxygen, a cathode electrode having a first surface in contact with the liquid and a second surface that allows the oxygen contained in the gas held in the hollow body to permeate, and being disposed with respect to the anode electrode via the liquid, and a resistor electrically coupled to the anode electrode and the cathode electrode.

A water purification system according to an aspect of the present disclosure is a water purification system installed in a liquid containing organic mud and electrochemically active bacteria, including an anode electrode disposed in the liquid, a hollow body holding a gas containing oxygen, a cathode electrode having a first surface in contact with the liquid and a second surface that allows the oxygen contained in the gas held in the hollow body to permeate, and being disposed with respect to the anode electrode via the liquid, and a resistor electrically coupled to the anode electrode and the cathode electrode.

### BRIEF DESCRIPTION OF THE DRAWINGS

FIG. 1 shows a schematic configuration of a liquid processing apparatus.

FIG. 2 shows a schematic configuration of a cathode electrode.

FIG. 3 shows a schematic configuration of a gas container.

FIG. 4 shows a schematic configuration of a gas container.

FIG. 5 shows a schematic configuration of a gas container.

FIG. 6 shows a schematic configuration of a gas container.

FIG. 7 shows a schematic configuration of a gas container.

FIG. 8 shows a schematic configuration of a liquid processing apparatus.

FIG. 9 shows a schematic configuration of a liquid processing apparatus.

FIG. 10 shows a schematic configuration of a liquid processing apparatus.

FIG. 11 shows a schematic configuration of a liquid processing apparatus.

FIG. 12 shows a schematic configuration of a MFC unit.

FIG. 13 shows a schematic configuration of a MFC unit.

FIG. 14 shows a schematic configuration of a MFC unit.

FIG. 15 shows a schematic configuration of a MFC unit.

FIG. 16 shows a schematic configuration of a MFC unit.

FIG. 17 shows a schematic configuration of a MFC unit.

FIG. 18 shows a schematic configuration of a MFC unit.

### DESCRIPTION OF EMBODIMENTS

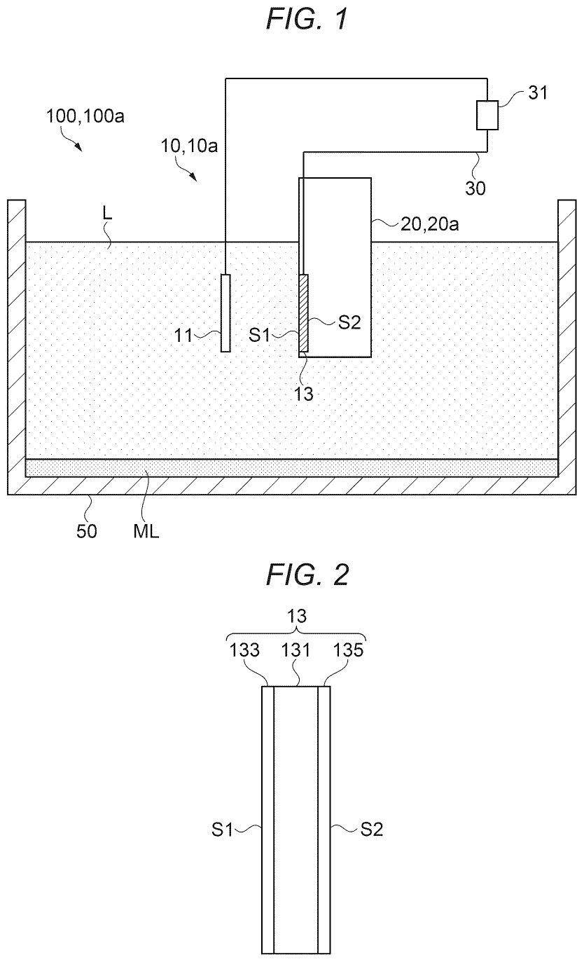

FIG. 1 shows a schematic configuration of a liquid processing apparatus 100. The liquid processing apparatus 100 is an apparatus that purifies organic wastewater L of domestic wastewater, industrial wastewater, and the like. The domestic wastewater, industrial wastewater, and the like include organic substances. The organic wastewater L corresponds to an example of a liquid. The domestic wastewater, industrial wastewater, and the like are collected from rivers, lakes, water channels, and the like. The liquid processing apparatus 100 purifies the organic wastewater L using microbes. The liquid processing apparatus 100 corresponds to an example of a water purification apparatus.

FIG. 1 shows a first liquid processing apparatus 100a as an example of the liquid processing apparatus 100. The first liquid processing apparatus 100a includes a first MFC unit 10a and a storage tank 50. The first MFC unit 10a is an example of a microbial fuel cell unit 10.

The MFC unit 10 decomposes the organic substances contained in the organic wastewater L using the microbes. The MFC unit 10 produces energy, useful substances, and the like by electrochemically controlling the metabolism of the microbes. The MFC unit 10 purifies the organic wastewater L by electrochemically controlling the metabolism of the microbes. The MFC unit 10 corresponds to an example of a water purification system. The MFC unit 10 includes an anode electrode 11, a cathode electrode 13, a gas container 20, and a coupling circuit 30.

FIG. 1 shows the first MFC unit 10a. The first MFC unit 10a includes a first gas container 20a as an example of the gas container 20.

The anode electrode 11 recovers electrons generated when the organic substances in the organic wastewater L are oxidized and decomposed by microbes. The anode electrode 11 is disposed in the organic wastewater L. The electrons recovered by the anode electrode 11 move to the cathode electrode 13 via the coupling circuit 30. The anode electrode 11 contacts the organic wastewater L held in the storage tank 50. On the anode electrode 11, the microbes contained in the organic wastewater L decompose the organic substances to generate electrons and hydrogen ions. The electrons generated by the microbes are recovered by the anode electrode 11.

The anode electrode 11 is formed using a conductive material such as a metal material or a carbon material. The metal material includes iron, stainless steel, titanium, aluminum, copper, and platinum. The carbon material includes graphite, carbon fiber, carbon cloth, carbon mat, graphite felt, and carbon paper. The material of the anode electrode 11 is not particularly limited as long as the material can receive electrons from microbes.

The cathode electrode 13 consumes the electrons moving through the coupling circuit 30 in reduction reaction of an oxidant. The cathode electrode 13 is disposed via the organic wastewater L with respect to the anode electrode 11. The electrons flow in the coupling circuit 30 according to gradients of the potential generated in the anode electrode 11 and the oxidation-reduction potential of the chemical reaction generated in the cathode electrode 13. The cathode electrode 13 uses oxygen in the atmosphere as the oxidant. Oxygen permeates the cathode electrode 13. Oxygen reacts with hydrogen ions moving in the organic wastewater L. The configuration of the cathode electrode 13 will be described later.

The cathode electrode 13 has an ion exchange surface S1 and an oxygen-permeable surface S2. The ion exchange surface S1 is in contact with the organic wastewater L. The ion exchange surface S1 corresponds to an example of a first surface. The oxygen-permeable surface S2 is in contact with a gas contained in the gas container 20. The oxygen-permeable surface S2 allows oxygen contained in the gas to permeate. The oxygen-permeable surface S2 corresponds to an example of a second surface.

The gas container 20 holds a gas containing oxygen. The gas container 20 supports the cathode electrode 13. The gas container 20 supports the cathode electrode 13 so that the oxygen-permeable surface S2 of the cathode electrode 13 can contact the held gas. The gas container 20 supplies oxygen to the cathode electrode 13. The gas container 20 is formed in a hollow tubular shape with a bottom. The gas container 20 is formed in a cylindrical shape, a quadrangular prism shape, or a polygonal shape. The gas container 20 corresponds to an example of a hollow body. The gas container 20 is provided, and thereby, oxygen is stably supplied to the cathode electrode 13. FIG. 1 shows the first gas container 20a as an example of the gas container 20. The configuration of the first gas container 20a will be described later.

The coupling circuit 30 is an electric circuit that moves electrons from the anode electrode 11 to the cathode electrode 13. The coupling circuit 30 is electrically coupled to the anode electrode 11 and the cathode electrode 13. The coupling circuit 30 includes a resistor 31. The resistor 31 is electrically coupled to the anode electrode 11 and the cathode electrode 13. The resistor 31 may be a variable resistor for which a resistance value is switched. The resistor 31 adjusts the amount of current flowing through the coupling circuit 30.

The storage tank 50 holds the organic wastewater L. The storage tank 50 may be coupled to an inflow path and an outflow path. The inflow path is a path through which water such as domestic wastewater and industrial wastewater flows into the storage tank 50. The water such as domestic wastewater and industrial wastewater is stored in the storage tank 50 as the organic wastewater L. The outflow path is a path through which the organic wastewater L flows out from the storage tank 50. The inflow path and the outflow path are not shown. The storage tank 50 corresponds to an example of a container body.

The organic wastewater L contains organic substances and microbes. The organic wastewater L is, for example, water collected from lakes, rivers, or the like. The organic wastewater L may contain organic mud collected from lakes or the like. The organic mud precipitates in the storage tank 50 to form a bottom mud layer ML. The bottom mud layer ML includes the organic wastewater L. The bottom mud layer ML corresponds to an example of an organic mud layer. The organic substances contained in the organic wastewater L are consumed as fuel for microbes.

The microbes are electrochemically active bacteria that decompose the organic substances in the organic wastewater L. The electrochemically active bacteria include Geobacter bacteria, Shawanella bacteria, Aeromonas bacteria, Geothrix bacteria, and Saccharomyces bacteria. The microbes may be contained in the organic wastewater L in advance or may be put into the organic wastewater L. The microbes may be supported by the anode electrode 11 with a biofilm or the like.

The first liquid processing apparatus 100a includes the storage tank 50 holding the organic wastewater L containing organic substances and electrochemical active bacteria, the anode electrode 11 disposed in the organic wastewater L, the first gas container 20a holding the gas containing oxygen, the cathode electrode 13 having the ion exchange surface S1 in contact with the organic wastewater L and the oxygen-permeable surface S2 that allows oxygen contained in the gas held in the gas container 20 to permeate therethrough, and disposed via the organic wastewater L with respect to the anode electrode 11, and the resistor 31 electrically coupled to the anode electrode 11 and the cathode electrode 13.

The first gas container 20a is provided, and thereby, the first liquid processing apparatus 100a can stably supply oxygen to the cathode electrode 13. The oxidation-reduction reaction in the cathode electrode 13 is stabilized. Water purification by the first liquid processing apparatus 100a is stably performed.

FIG. 2 shows a schematic configuration of the cathode electrode 13. FIG. 2 shows a cross-sectional configuration of the cathode electrode 13. The cathode electrode 13 includes a base material layer 131, a filter layer 133, and a water repelling layer 135. The outer surface of the filter layer 133 is the ion exchange surface S1. The outer surface of the water repelling layer 135 is the oxygen-permeable surface S2.

The base material layer 131 is formed using a conductive material such as a metal material or a carbon material. The base material layer 131 is preferably formed using a carbon material. A layer formed using a carbon material has a larger surface area and higher electrical conductivity than a layer formed using a metal material. The metal material includes iron, stainless steel, titanium, aluminum, copper, and platinum. The carbon material includes graphite, carbon fiber, carbon cloth, carbon mat, graphite felt, and carbon paper. The material of the base material layer 131 is not particularly limited as long as the material has conductivity. The base material layer 131 is preferably porous. The base material layer 131 has oxygen permeability.

The filter layer 133 prevents microbes from entering the base material layer 131. The filter layer 133 moves hydrogen ions to the base material layer 131. The filter layer 133 is formed using, for example, an ion exchange resin. The ion exchange resin includes NAFION manufactured by DuPont Kabushiki Kaisha, FLEMION manufactured by AGC Inc., and SELEMION manufactured by AGC Inc. NAFION, FLEMION, and SELEMION are registered trademarks.

The filter layer 133 contains a catalyst material. The catalyst material functions as a catalyst for an oxidation-reduction reaction. Examples of the catalyst material include noble metals such as platinum, cobalt, ruthenium, and iridium, and noble metal alloys. The catalyst material may be noble metal-supported carbon, noble metal-alloy-supported carbon, or a noble metal compound such as platinum phthalocyanine, or ruthenium phthalocyanine. The catalyst material may be a metal compound such as iron oxide, cobalt oxide, iron nitride, iron phosphate, or cementite, a metal complex compound such as iron phthalocyanine, iron azaphthalocyanine, iron porphyrin, cobalt phthalocyanine, cobalt azaphthalocyanine, or cobalt porphyrin. The catalyst material is preferably a noble metal, a noble metal compound, or a metal compound.

The water repelling layer 135 prevents the organic wastewater L from adhering to the base material layer 131. The water repelling layer 135 has oxygen permeability and water repellency. The water repelling layer 135 allows oxygen in the atmosphere to permeate the base material layer 131. The water repelling layer 135 is formed using a nonwoven fabric of polyethylene, polypropylene, or the like a film of polytetrafluoroethylene (PTFE) or the like, a composite film of a composite polyurethane polymer or the like, beeswax, or the like. The water repelling layer 135 is, for example, a PTFE layer. The PTFE layer is produced by application of a 30 to 80% PTFE solution to one surface of the base material layer 131 and drying.

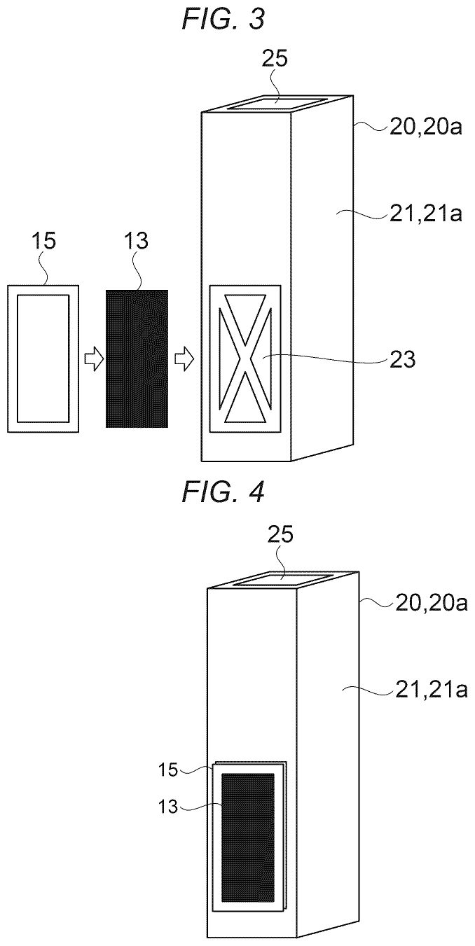

FIG. 3 shows a schematic configuration of the gas container 20. FIG. 3 shows a schematic configuration of a first gas container 20a as an example of the gas container 20. FIG. 3 shows the configuration of the first gas container 20a with the cathode electrode 13 removed. The cathode electrode 13 and a fixing jig 15 are attached to the first gas container 20a.

The first gas container 20a includes a first container exterior body 21a. The first container exterior body 21a is an example of a container exterior body 21. The first container exterior body 21a is a tubular body having a bottom surface. The first container exterior body 21a has a side opening portion 23 and a top opening portion 25.

The side opening portion 23 is an opening provided in the first container exterior body 21a. The side opening portion 23 is provided in a side surface of the first container exterior body 21a. The side surface of the first container exterior body 21a is different from the bottom surface of the first container exterior body 21a. The cathode electrode 13 is attached to the side opening portion 23. The cathode electrode 13 covers the side opening portion 23. The cathode electrode 13 is attached to the side opening portion 23, and thereby, the oxygen-permeable surface S2 of the cathode electrode 13 can come into contact with the gas held in the first gas container 20a. The side opening portion 23 corresponds to an example of a first opening.

The top opening portion 25 is an opening provided in the first container exterior body 21a. The top opening portion 25 is provided in the top surface of the first container exterior body 21a. The top surface of the first container exterior body 21a is a surface positioned at the upside along the vertical axis when the cathode electrode 13 is placed in the organic wastewater L. The top opening portion 25 is positioned outside the organic wastewater L when the cathode electrode 13 is placed in the organic wastewater L. The top opening portion 25 allows a gas to flow through the first gas container 20a. The top opening portion 25 corresponds to an example of a second opening.

The cathode electrode 13 is attached to the first container exterior body 21a in the position of the side opening portion 23. The cathode electrode 13 is attached to the first container exterior body 21a and forms a part of the first container exterior body 21a. The ion exchange surface S1 of the cathode electrode 13 can come into contact with the organic wastewater L. The cathode electrode 13 contacts the organic wastewater L at the ion exchange surface S1 and can contact the gas at the oxygen-permeable surface S2.

The fixing jig 15 fixes the cathode electrode 13 to the first container exterior body 21a. The fixing jig 15 contacts the outer peripheral portion of the cathode electrode 13 and fixes the cathode electrode 13 to the first container exterior body 21a. The fixing jig 15 is attached to the first container exterior body 21a via the cathode electrode 13. The fixing jig 15 shown in FIG. 3 has the configuration in contact the outer peripheral portion of the cathode electrode 13, but the configuration is not limited thereto. The configuration of the fixing jig 15 is not limited as long as the cathode electrode 13 can be fixed to the first container exterior body 21a.

FIG. 4 shows a schematic configuration of the gas container 20. FIG. 4 shows a schematic configuration of the first gas container 20a as the example of the gas container 20. FIG. 4 shows the first gas container 20a to which the cathode electrode 13 is attached.

The cathode electrode 13 is attached to the first container exterior body 21a. The cathode electrode 13 is attached in the position where the side opening portion 23 is provided. The cathode electrode 13 is fixed to the first container exterior body 21a by the fixing jig 15. The cathode electrode 13 covers the side opening portion 23. The cathode electrode 13 can prevent the organic wastewater L from entering the gas container 20 by covering the side opening portion 23.

The first gas container 20a is a tubular body having the side opening portion 23 and the top opening portion 25. The cathode electrode 13 is preferably attached to the side opening portion 23 and covers the side opening portion 23.

Since the cathode electrode 13 is attached to the side opening portion 23, the oxygen-permeable surface S2 of the cathode electrode 13 can allow oxygen contained in the gas held in the first gas container 20a to permeate. The cathode electrode 13 covers the side opening portion 23, and thereby, the organic wastewater L is prevented from entering the first gas container 20a.

FIG. 5 shows a schematic configuration of the gas container 20. FIG. 5 shows a schematic configuration of a second gas container 20b as an example of the gas container 20. FIG. 5 shows the second gas container 20b to which the cathode electrode 13 is attached. The second gas container 20b includes a sealing member 27. The second gas container 20b has the same configuration as the first gas container 20a except for the sealing member 27.

The sealing member 27 covers the top opening portion 25. The sealing member 27 seals the top opening portion 25. The sealing member 27 air-tightly seals the interior of the second gas container 20b. The sealing member 27 is provided, and thereby, the entire second gas container 20b can be immersed in the organic wastewater L. The second gas container 20b immersed in the organic wastewater L can supply oxygen contained in the gas to the cathode electrode 13. The sealing member 27 may be fixedly disposed on the first container exterior body 21a or may be detachably formed. The sealing member 27 may be provided to be openable and closable with respect to the first container exterior body 21a. The sealing member 27 corresponds to an example of a lid member.

The second gas container 20b preferably includes the sealing member 27 that seals the top opening portion 25.

The sealing member 27 is provided, and thereby, the entire second gas container 20b can be immersed in the organic wastewater L. The second gas container 20b immersed in the organic wastewater L can supply oxygen contained in the gas to the cathode electrode 13.

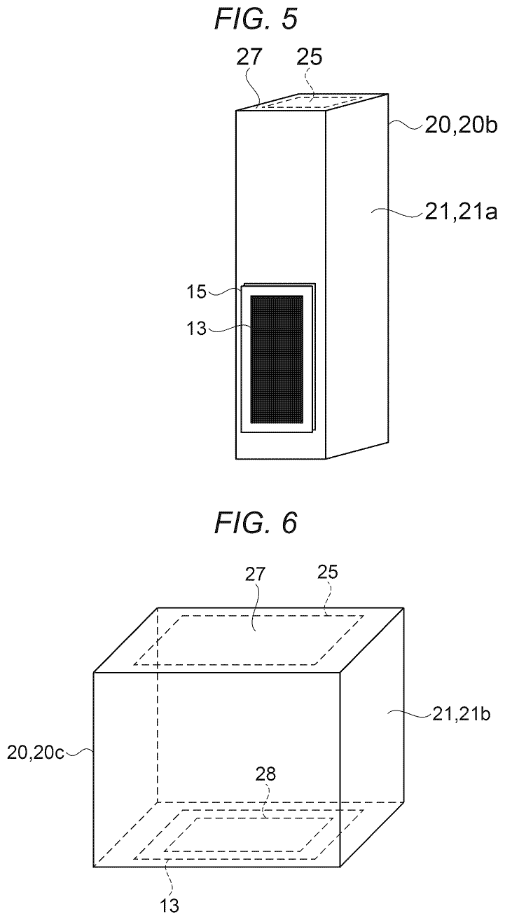

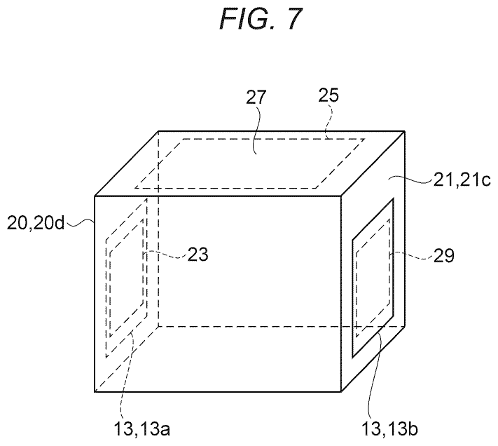

FIG. 6 shows a schematic configuration of the gas container 20. FIG. 6 shows a schematic configuration of a third gas container 20c as an example of the gas container 20. FIG. 6 shows the third gas container 20c to which the cathode electrode 13 is attached. The third gas container 20c includes a sealing member 27. The third gas container 20c includes a second container exterior body 21b as an example of the container exterior body 21. The third gas container 20c has the same configuration as the second gas container 20b except for the configuration of the container exterior body 21 and the arrangement position of the cathode electrode 13.

The second container exterior body 21b has a top opening portion 25 and a bottom opening portion 28. The second container exterior body 21b does not have the side opening portion 23. The top opening portion 25 of the second container body exterior 21b has the same configuration as the top opening portion 25 of the first container exterior body 21a. The top opening portion 25 shown in FIG. 6 is sealed by the sealing member 27, but is not limited thereto. The third gas container 20c does not necessarily include the sealing member 27. The second container exterior body 21b shown in FIG. 6 has an appearance shape different from that of the first container exterior body 21a shown in FIGS. 4 and 5, however, the shape is not limited thereto. The second container exterior body 21b may have the same appearance shape as the first container exterior body 21a or may have a different appearance shape.

The bottom opening portion 28 is an opening provided in the second container exterior body 21b. The bottom opening portion 28 is provided in the bottom surface of the second container exterior body 21b. The bottom surface of the second container outer body 21b is a surface positioned at the downside along the vertical axis when the third gas container 20c is immersed in the organic wastewater L. When the cathode electrode 13 is placed in the organic wastewater L, the bottom opening portion 28 is positioned in a position facing the bottom surface of the storage tank 50 or a bottom surface of a lake or the like. The bottom opening portion 28 corresponds to an example of the first opening.

The cathode electrode 13 is attached to the bottom opening portion 28. The cathode electrode 13 covers the bottom opening portion 28. The cathode electrode 13 is fixed to the second container exterior body 21b by a fixing jig 15 (not shown). The cathode electrode 13 is attached in a position covering the bottom opening portion 28, and thereby, positioned in the position facing the bottom surface of the storage tank 50 or the bottom surface of the lake or the like.

FIG. 7 shows a schematic configuration of the gas container 20. FIG. 7 shows a schematic configuration of a fourth gas container 20d as an example of the gas container 20. FIG. 7 shows the fourth gas container 20d to which cathode electrodes 13 are attached. The fourth gas container 20d has a sealing member 27. The fourth gas container 20d includes a third container exterior body 21c as an example of the container exterior body 21. The fourth gas container 20d has the same configuration as the first gas container 20a except for the configuration of the first container exterior body 21a and the arrangement positions of the cathode electrodes 13.

A first cathode electrode 13a and a second cathode electrode 13b are attached to the fourth gas container 20d. Each of the first cathode electrode 13a and the second cathode electrode 13b is an example of the cathode electrode 13. The first cathode electrode 13a and the second cathode electrode 13b are coupled to a coupling circuit 30 (not shown).

The third container exterior body 21c has a side opening portion 23, a top opening portion 25, and a second side opening portion 29. The side opening portion 23 of the third container exterior body 21c has the same configuration as the side opening portion 23 of the first container exterior body 21a. The top opening portion 25 of the third container exterior body 21c has the same configuration as the top opening portion 25 of the first container exterior body 21a. The top opening portion 25 shown in FIG. 7 is sealed by the sealing member 27, but is not limited thereto. The fourth gas container 20d does not necessarily include the sealing member 27. The third container exterior body 21c shown in FIG. 7 has an appearance shape different from that of the first container exterior body 21a shown in FIGS. 4 and 5, but not limited thereto. The third container exterior body 21c may have the same appearance shape as the first container exterior body 21a or may have a different appearance shape.

The first cathode electrode 13a as an example of the cathode electrode 13 is attached to the side opening portion 23. The side opening portion 23 is covered by the first cathode electrode 13a. The first cathode electrode 13a is attached to the side opening portion 23, and thereby, the first cathode electrode 13a can come into contact with the gas held in the fourth gas container 20d. The first cathode electrode 13a is fixed in the position of the side opening portion 23 of the third container exterior body 21c by a fixing jig 15 (not shown).

The second side opening portion 29 is an opening provided in the third container exterior body 21c. The second side opening portion 29 is provided in a side surface of the third container exterior body 21c. The second side opening portion 29 is provided in the side surface in a position different from that of the side surface in which the side opening portion 23 is provided. The second cathode electrode 13b as an example of the cathode electrode 13 is attached to the second side opening portion 29. The second side opening portion 29 is covered by the second cathode electrode 13b. The second cathode electrode 13b is attached to the second side opening portion 29, and thereby, the second cathode electrode 13b can come into contact with the gas held in the fourth gas container 20d. The second cathode electrode 13b is fixed in the position of the second side opening portion 29 of the third container exterior body 21c by a fixing jig 15 (not shown). The second side opening portion 29 corresponds to an example of the first opening.

The third container exterior body 21c shown in FIG. 7 has the side opening portion 23, the top opening portion 25, and the second side opening portion 29, but is not limited thereto. The third container exterior body 21c may be provided with openings including the bottom opening portion 28 and a third side opening (not shown). A cathode electrode 13 is attached to each opening portion. Each opening portion is covered by the cathode electrode 13.

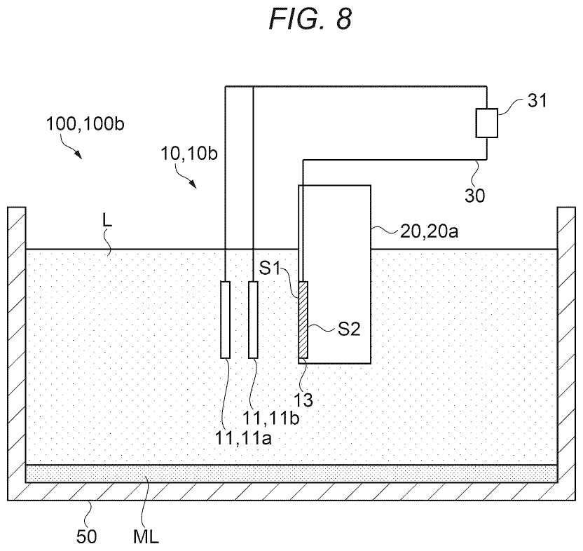

FIG. 8 shows a schematic configuration of the liquid processing apparatus 100. FIG. 8 shows a second liquid processing apparatus 100b as an example of the liquid processing apparatus 100. The second liquid processing apparatus 100b includes a second MFC unit 10b and a storage tank 50. The second MFC unit 10b is an example of the MFC unit 10. The storage tank 50 of the second liquid processing apparatus 100b has the same configuration as the storage tank 50 of the first liquid processing apparatus 100a.

The second MFC unit 10b includes a first anode electrode 11a, a second anode electrode 11b, a cathode electrode 13, a first gas container 20a, and a coupling circuit 30. The cathode electrode 13 and the first gas container 20a of the second MFC unit 10b have the same configurations as the cathode electrode 13 and the first gas container 20a of the first MFC unit 10a, respectively.

The first anode electrode 11a and the second anode electrode 11b are examples of the anode electrode 11. The first anode electrode 11a and the second anode electrode 11b recover electrons generated when the organic substances in the organic wastewater L are oxidized and decomposed by microbes. The second MFC unit 10b includes the two anode electrodes 11. Since the second MFC unit 10b includes the two anode electrodes 11, the surface area of the contact surfaces of the anode electrodes 11 in contact with the organic wastewater L is larger than the surface area of the ion exchange surface S1 of the cathode electrode 13. The amount of electrons recovered by the anode electrodes 11 per unit surface area is smaller than the amount of electrons consumed in the cathode electrode 13 per unit surface area. As the surface area of the anode electrodes 11 increases, the amount of electrons recovered in the anode electrodes 11 increases. As the amount of electrons recovered in the anode electrodes 11 increases, the maximum output power of the second MFC unit 10b increases. The purification capacity of water by the second MFC unit 10b is increased.

The second MFC unit 10b includes the two anode electrodes 11, but is not limited thereto. The second MFC unit 10b may include three or more anode electrodes 11. The second MFC unit 10b includes the two anode electrodes 11 to increase the surface area of the anode electrodes 11, but is not limited thereto. A single anode electrode 11 having a larger surface area than the cathode electrode 13 may be used.

The coupling circuit 30 is coupled to the first anode electrode 11a, the second anode electrode 11b, and the cathode electrode 13. The resistor 31 is electrically coupled to the first anode electrode 11a, the second anode electrode 11b, and the cathode electrode 13. The coupling circuit 30 moves the electrons recovered by the first anode electrode 11a and the second anode electrode 11b to the cathode electrode 13.

The surface area of the contact surfaces of the anode electrodes 11 in contact with the organic wastewater L is preferably larger than the surface area of the ion exchange surface S1 of the cathode electrode 13.

When the amount of electrons supplied at the anode electrodes 11 increases, the maximum output power of the second MFC unit 10b increases. The purification capacity of water by the second MFC unit 10b is increased.

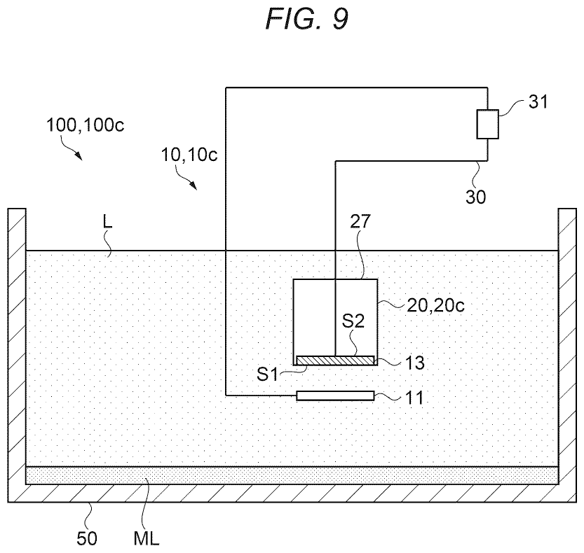

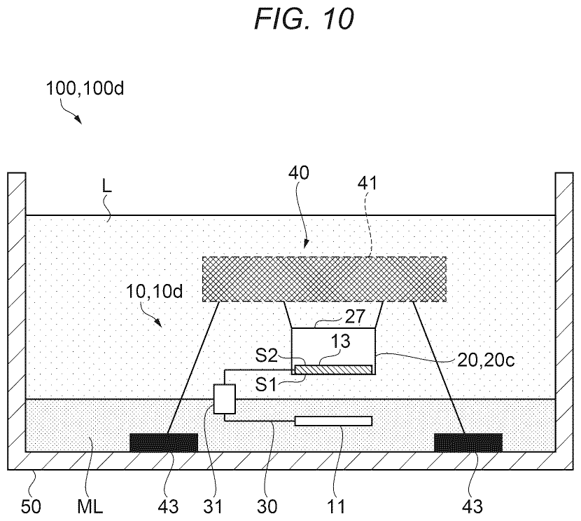

FIG. 9 shows a schematic configuration of the liquid processing apparatus 100. FIG. 9 shows a third liquid processing apparatus 100c as an example of the liquid processing apparatus 100. The third liquid processing apparatus 100c includes a third MFC unit 10c and a storage tank 50. The third MFC unit 10c is an example of the MFC unit 10. The storage tank 50 of the third liquid processing apparatus 100c has the same configuration as the storage tank 50 of the first liquid processing apparatus 100a.

The third MFC unit 10c includes an anode electrode 11, a cathode electrode 13, a third gas container 20c, and a coupling circuit 30. The anode electrode 11 and the coupling circuit 30 of the third MFC unit 10c have the same configurations as the anode electrode 11 and the coupling circuit 30 of the first MFC unit 10a, respectively.

The cathode electrode 13 attached to the third gas container 20c is disposed along the bottom surface of the storage tank 50. The ion exchange surface S1 of the cathode electrode 13 is disposed to face the bottom surface of the storage tank 50. The cathode electrode 13 is placed in the organic wastewater L stored in the lower part of the storage tank 50.

The anode electrode 11 is positioned in a position facing the ion exchange surface S1 of the cathode electrode 13. The anode electrode 11 is disposed below the cathode electrode 13. The anode electrode 11 is placed in the organic wastewater L stored in the lower part of the storage tank 50. The anode electrode 11 is disposed along the bottom surface of the storage tank 50. Since the organic substances contained in the organic wastewater L are heavier than water, the organic substances fall to the lower part of the storage tank 50. The content of the organic substances contained in the organic wastewater L increases toward the downside of the storage tank 50. The anode electrode 11 and the cathode electrode 13 are placed in the lower part of the storage tank 50, and thereby, the purification function of the third MFC unit 10c for the organic wastewater L is increased.

The third gas container 20c is disposed in the organic wastewater L. The third gas container 20c includes a sealing member 27. The third gas container 20c prevents the organic wastewater L from entering the third gas container 20c by the sealing member 27. The cathode electrode 13 is stably supplied with oxygen.

The anode electrode 11 is preferably disposed along the bottom surface of the storage tank 50, and the ion exchange surface S1 of the cathode electrode 13 is preferably provided in a position facing the anode electrode 11.

The third MFC unit 10c can purify the organic wastewater L containing a larger amount of organic substances.

FIG. 10 shows a schematic configuration of the liquid processing apparatus 100. FIG. 10 shows a fourth liquid processing apparatus 100d as an example of the liquid processing apparatus 100. The fourth liquid processing apparatus 100d includes a fourth MFC unit 10d and a storage tank 50. The storage tank 50 of the fourth liquid processing apparatus 100d has the same configuration as the storage tank 50 of the first liquid processing apparatus 100a.

The fourth MFC unit 10d includes an anode electrode 11, a cathode electrode 13, a third gas container 20c, a coupling circuit 30, and a fixing member 40. The anode electrode 11, the cathode electrode 13, the third gas container 20c, and the coupling circuit 30 of the fourth MFC unit 10d have the same configurations as the anode electrode 11, the cathode electrode 13, the third gas container 20c, and the coupling circuit 30 of the third MFC unit 10c, respectively.

The fixing member 40 fixes and supports the third gas container 20c in the organic wastewater L. The fixing member 40 fixes and supports the third gas container 20c in the organic wastewater L, and thereby, positions the cathode electrode 13 in a predetermined position in the organic wastewater L. Since the third gas container 20c holds the gas, the specific gravity of the third gas container 20c is smaller than the specific gravity of the organic wastewater L. It is difficult to maintain the third gas container 20c in the predetermined position in the organic wastewater L due to buoyancy. Since the fixing member 40 fixes and supports the third gas container 20c, the position of the third gas container 20c is less likely to vary. The fixing member 40 corresponds to an example of a supporting member. The fixing member 40 has a supporting net 41 and a plurality of weights 43.

The supporting net 41 is disposed in the organic wastewater L. The supporting net 41 supports the third gas container 20c. The supporting net 41 suppresses variations in position of the third gas container 20c due to floating of the third gas container 20c. The supporting net 41 shown in FIG. 10 supports the third gas container 20c below the supporting net 41, but is not limited thereto. The supporting net 41 may support the third gas container 20c inside the supporting net 41.

The weights 43 fix the supporting net 41. The weights 43 are fixed to the bottom surface of the storage tank 50. The weights 43 may be fixed by a bottom mud layer ML. The weights 43 prevent the supporting net 41 from moving due to the flow of the organic wastewater L or the like. The fixing member 40 shown in FIG. 10 has the two weights 43, but is not limited thereto. The fixing member 40 may include one, three, or more weights 43.

The anode electrode 11 of the fourth MFC unit 10d shown in FIG. 10 is disposed in the bottom mud layer ML. The content of the organic substances in the bottom mud layer ML is larger than the content of the organic substances in the organic wastewater L. The anode electrode 11 is disposed in the bottom mud layer ML, and thereby, the effect of water purification is increased.

The fourth liquid processing apparatus 100d preferably includes the fixing member 40 that places the cathode electrode 13 in the organic wastewater L.

Since the fixing member 40 fixes and supports the third gas container 20c, the position of the cathode electrode 13 attached to the third gas container 20c is less likely vary.

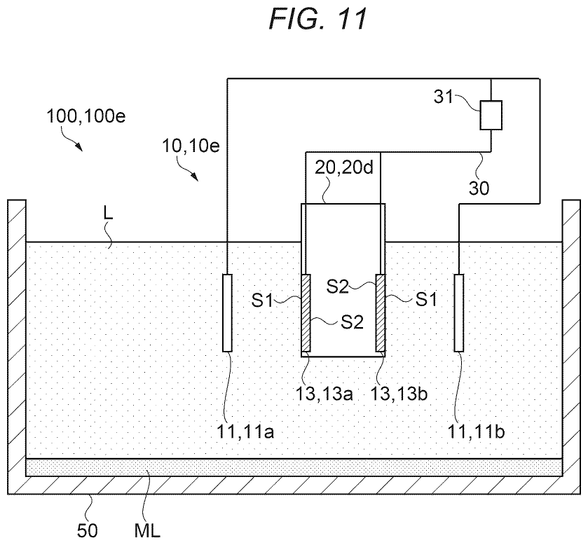

FIG. 11 shows a schematic configuration of the liquid processing apparatus 100. FIG. 11 shows a fifth liquid processing apparatus 100e as an example of the liquid processing apparatus 100. The fifth liquid processing apparatus 100e includes a fifth MFC unit 10e and a storage tank 50. The fifth MFC unit 10e is an example of the MFC unit 10. The storage tank 50 of the fifth liquid processing apparatus 100e has the same configuration as the storage tank 50 of the first liquid processing apparatus 100a.

The fifth MFC unit 10e includes a first anode electrode 11a, a second anode electrode 11b, a first cathode electrode 13a, a second cathode electrode 13b, a fourth gas container 20d, and a coupling circuit 30.

The first anode electrode 11a is positioned in a position facing the first cathode electrode 13a. The second anode electrode 11b is positioned in a position facing the second cathode electrode 13b. The first anode electrode 11a and the second anode electrode 11b are positioned in the positions facing the first cathode electrode 13a and the second cathode electrode 13b, respectively, and thereby, hydrogen ions easily move to the first cathode electrode 13a or the second cathode electrode 13b in the organic wastewater L.

The fifth MFC unit 10e shown in FIG. 11 includes the two anode electrodes 11 and the two cathode electrodes 13, but is not limited thereto. The fifth MFC unit 10e may include three or more anode electrodes 11. The fifth MFC unit 10e includes a cathode electrode 13 in a position facing each of the three or more anode electrodes 11. The increase in the number of the anode electrodes 11 and the cathode electrodes 13 increases the water purification capacity of the fifth MFC unit 10e.

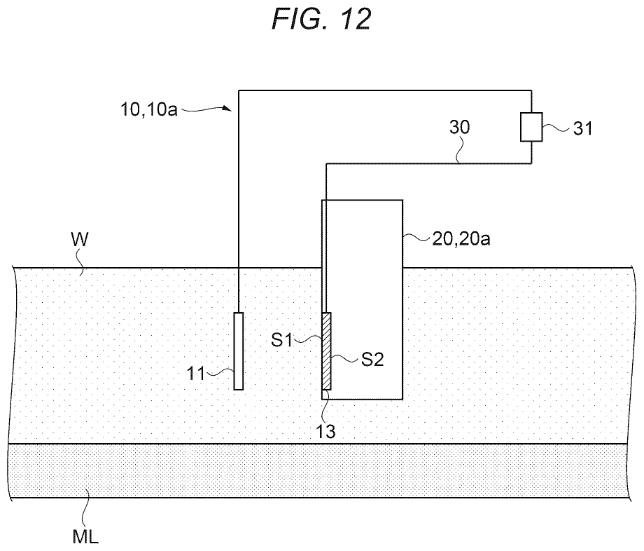

FIG. 12 shows a schematic configuration of the MFC unit 10. FIG. 12 shows a configuration of the MFC unit 10 installed in a lake, a river, or the like. FIG. 12 shows a first MFC unit 10a as an example of the MFC unit 10. FIG. 12 shows a first MFC unit 10a installed in a lake as an example of a lake, a river, or the like.

The first MFC unit 10a purifies the water of lake water W. The first MFC unit 10a shown in FIG. 12 is installed in the lake water W. The first MFC unit 10a purifies the lake water W on site. The lake water W is an example of the liquid. The lake water W contains organic mud and microbes. The microbes contain electrochemically active bacteria. A bottom mud layer ML in which organic mud is layered is formed on the bottom of the lake. The bottom mud layer ML corresponds to an example of an organic mud layer. The organic mud contains organic substances. The first MFC unit 10a purifies the water of the lake water W by decomposing the organic substances contained in the lake water W and the bottom mud layer ML.

The first MFC unit 10a includes an anode electrode 11, a cathode electrode 13, a first gas container 20a, and a coupling circuit 30. A first gas container 20a is an example of the gas container 20. In the first MFC unit 10a shown in FIG. 12, the anode electrode 11 and the cathode electrode 13 are immersed in lake water W.

The anode electrode 11 recovers electrons generated when organic substances in the lake water W are oxidized and decomposed by microbes. The electrons recovered by the anode electrode 11 move to the cathode electrode 13 via the coupling circuit 30. The anode electrode 11 contacts the lake water W. On the anode electrode 11, the microbes contained in the lake water W decompose the organic substances to generate electrons and hydrogen ions. The electrons generated by the microbes are recovered by the anode electrode 11.

The cathode electrode 13 consumes the electrons moving through the coupling circuit 30 in reduction reaction of an oxidant. The cathode electrode 13 is disposed with respect to the anode electrode 11 via the lake water W. The electrons flow in the coupling circuit 30 according to gradients of the potential generated in the anode electrode 11 and the oxidation-reduction potential of the chemical reaction generated in the cathode electrode 13. The cathode electrode 13 uses oxygen in the atmosphere as the oxidant. Oxygen permeates the cathode electrode 13.

The cathode electrode 13 has an ion exchange surface S1 and an oxygen-permeable surface S2. The ion exchange surface S1 contacts the lake water W. The oxygen-permeable surface S2 contacts the gas held in the first gas container 20a. The oxygen-permeable surface S2 allows oxygen contained in the gas to permeate.

The first gas container 20a holds a gas containing oxygen. The first gas container 20a supports the cathode electrode 13. The first gas container 20a supports the cathode electrode 13 so that the oxygen-permeable surface S2 of the cathode electrode 13 can contact the held gas. The first gas container 20a supplies oxygen to the cathode electrode 13. The first gas container 20a is formed in a hollow tubular shape with a bottom. The first gas container 20a is formed in a cylindrical shape, a quadrangular prism shape, or a polygonal shape. The first gas container 20a is provided, and thereby, oxygen is stably supplied to the cathode electrode 13.

The coupling circuit 30 is an electric circuit that moves electrons from the anode electrode 11 to the cathode electrode 13. The coupling circuit 30 is coupled to the anode electrode 11 and the cathode electrode 13. The coupling circuit 30 includes a resistor 31. The resistor 31 is electrically coupled to the anode electrode 11 and the cathode electrode 13. The resistor 31 may be a variable resistor for which a resistance value is switched. The resistor 31 adjusts the amount of current flowing through the coupling circuit 30.

The first MFC unit 10a is installed in the lake water W containing organic mud and electrochemically active bacteria. The first MFC unit 10a includes the anode electrode 11 disposed in the lake water W, the first gas container 20a holding the gas containing oxygen, the cathode electrode 13 having the ion exchange surface S1 in contact with the lake water W and the oxygen-permeable surface S2 allowing oxygen contained in the gas held in the first gas container 20a to permeate and disposed with respect to the anode electrode 11 via the lake water W, and the resistor 31 electrically coupled to the anode electrode 11 and the cathode electrode 13.

The first gas container 20a is provided, and thereby, the first MFC unit 10a can stably supply oxygen to the cathode electrode 13. The oxidation-reduction reaction in the cathode electrode 13 is stabilized. Water purification by the first MFC unit 10a is stably performed.

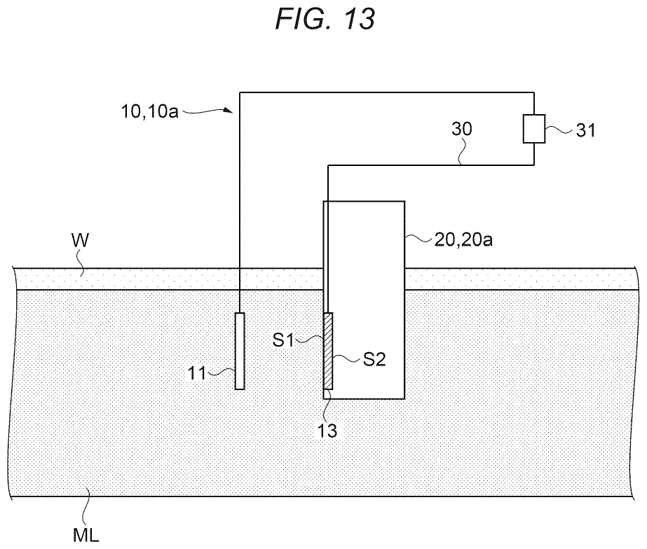

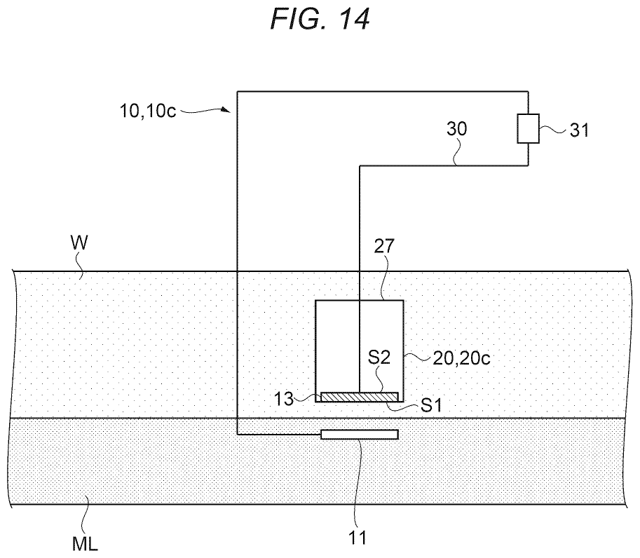

FIG. 13 shows a schematic configuration of the MFC unit 10. FIG. 13 shows the configuration of the MFC unit 10 installed in a lake, a river, or the like. FIG. 13 shows a placement example of the MFC unit 10. FIG. 13 shows a first MFC unit 10a as an example of the MFC unit 10.

An anode electrode 11 and a cathode electrode 13 provided in the first MFC unit 10a are disposed in a bottom mud layer ML. An ion exchange surface S1 of the cathode electrode 13 is disposed to face the anode electrode 11. The bottom mud layer ML contains organic mud, electrochemically active bacteria, and lake water W. In the bottom mud layer ML, the electrochemically active bacteria decompose organic substances contained in the organic mud to generate electrons and hydrogen ions. The anode electrode 11 recovers electrons generated by the electrochemically active bacteria. The anode electrode 11 recovers electrons, and thereby, decomposition of the organic substances by the electrochemically active bacteria is continuously performed. The first MFC unit 10a can purify the lake water W by decomposing the organic substances contained in the bottom mud layer ML.

The bottom mud layer ML in which organic mud is layered is formed in the lake water W. The anode electrode 11 is disposed in the bottom mud layer ML. An ion exchange surface S1 of the cathode electrode 13 is disposed to face the anode electrode 11.

The first MFC unit 10a can decompose organic substances contained in the bottom mud layer ML. The first MFC unit 10a can purify the lake water W by decomposing the organic substances contained in the bottom mud layer ML.

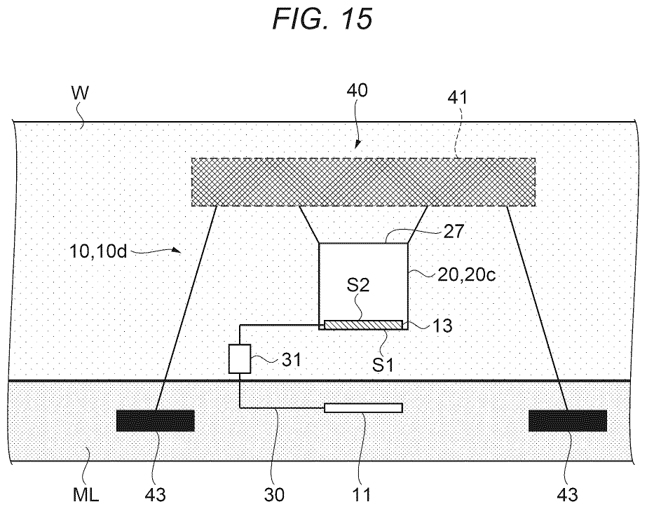

FIG. 14 shows a schematic configuration of the MFC unit 10. FIG. 14 shows the configuration of the MFC unit 10 installed in a lake, a river, or the like. FIG. 14 shows a placement example of the MFC unit 10. FIG. 14 shows a third MFC unit 10c as an example of the MFC unit 10.

An anode electrode 11 provided in the third MFC unit 10c is disposed in a bottom mud layer ML. The cathode electrode 13 is disposed in lake water W. An ion exchange surface S1 of the cathode electrode 13 is disposed to face the anode electrode 11. The anode electrode 11 and the cathode electrode 13 are disposed to face each other via the lake water W and the bottom mud layer ML. In the bottom mud layer ML, electrochemically active bacteria decompose organic substances contained in the organic mud to generate electrons and hydrogen ions. The anode electrode 11 recovers electrons generated by the electrochemically active bacteria in the bottom mud layer ML. The anode electrode 11 recovers electrons, and thereby, decomposition of the organic substances by the electrochemically active bacteria is continuously performed. The third MFC unit 10c can purify the lake water W by decomposing the organic substances contained in the bottom mud layer ML.

The third gas container 20c includes a sealing member 27. The third gas container 20c is disposed in the lake water W. The cathode electrode 13 is disposed on the bottom surface of the third gas container 20c. The third gas container 20c to which the cathode electrode 13 is attached is disposed in the lake water W, and thereby, the ion exchange surface S1 of the cathode electrode 13 can be positioned in a position at a predetermined distance from the anode electrode 11 in the bottom mud layer ML. Further, the third gas container 20c is provided, and thereby, oxygen can be supplied to an oxygen-permeable surface S2 of the cathode electrode 13. The purification function of the lake water W by the third MFC unit 10c is continuously maintained.

FIG. 15 shows a schematic configuration of the MFC unit 10. FIG. 15 shows the configuration of the MFC unit 10 installed in a lake, a river, or the like. FIG. 15 shows a placement example of the MFC unit 10. FIG. 15 shows a fourth MFC unit 10d as an example of the MFC unit 10. The fourth MFC unit 10d includes an anode electrode 11, a cathode electrode 13, a third gas container 20c, a coupling circuit 30, and a fixing member 40.

The anode electrode 11 is disposed in a bottom mud layer ML. The cathode electrode 13 is disposed in lake water W. An ion exchange surface S1 of the cathode electrode 13 is disposed to face the anode electrode 11. The anode electrode 11 and the cathode electrode 13 are disposed to face each other via the lake water W and the bottom mud layer ML.

The third gas container 20c includes a sealing member 27. The third gas container 20c is disposed in the lake water W. The cathode electrode 13 is disposed on the bottom surface of the third gas container 20c. The third gas container 20c is placed in the lake water W by the fixing member 40.

The fixing member 40 fixes and supports the third gas container 20c in the lake water W. The fixing member 40 supports cathode electrode 13 in a predetermined position by fixing and supporting the third gas container 20c in the lake water W. The cathode electrode 13 is disposed in the lake water W. Since the fixing member 40 fixes and supports the third gas container 20c, the position of the third gas container 20c is less likely to vary. The fixing member 40 corresponds to an example of the supporting member. The fixing member 40 has a supporting net 41 and a plurality of weights 43.

The supporting net 41 is disposed in the lake water W. The supporting net 41 supports the third gas container 20c. The supporting net 41 suppresses variations in position of the third gas container 20c due to floating of the third gas container 20c. The supporting net 41 shown in FIG. 15 supports the third gas container 20c below the supporting net 41, but is not limited thereto. The supporting net 41 may support the third gas container 20c inside the supporting net 41.

The weights 43 fix the supporting net 41. The weights 43 are fixed to the bottom surface of the lake. The weights 43 are fixed by the bottom mud layer ML as an example. The weights 43 prevent the supporting net 41 from moving due to the flow of the lake water W or the like. The fixing member 40 shown in FIG. 15 includes the two weights 43, but is not limited thereto. The fixing member 40 may include one, three, or more weights 43.

The anode electrode 11 of the fourth MFC unit 10d shown in FIG. 15 is disposed in the bottom mud layer ML. The content of the organic substances in the bottom mud layer ML is 1 larger than the content of the organic substances in the lake water W. The anode electrode 11 is disposed in the bottom mud layer ML, and thereby, the effect of water purification is increased.

It is preferable to provide the fixing member 40 that places the cathode electrode 13 in the lake water W.

Since the fixing member 40 fixes and supports the third gas container 20c, the position of the cathode electrode 13 attached to the third gas container 20c is less likely vary.

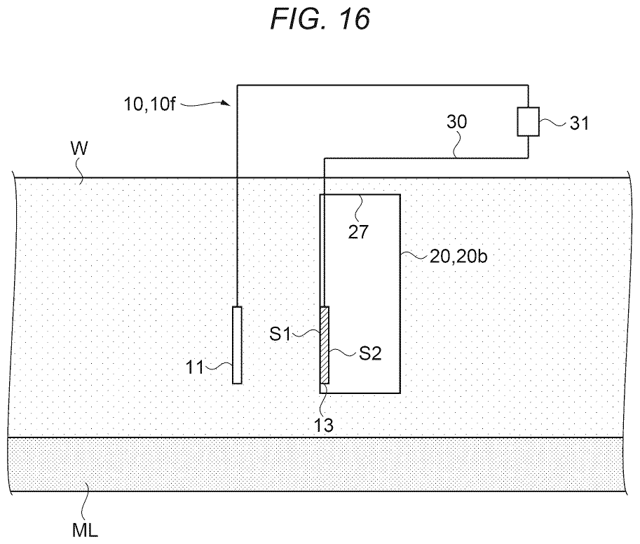

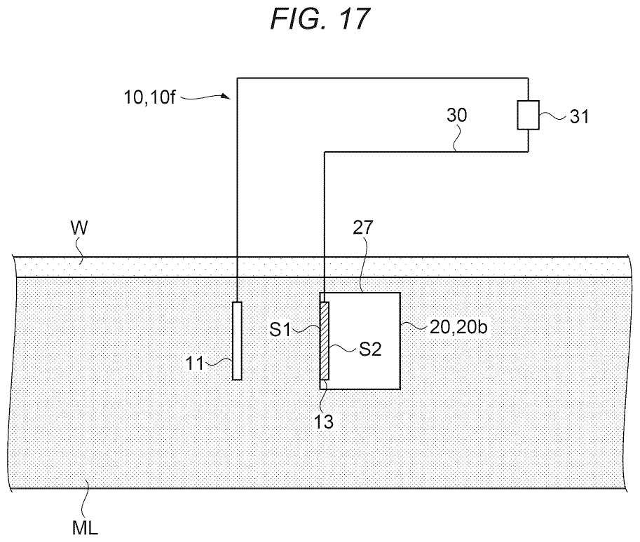

FIG. 16 shows a schematic configuration of the MFC unit 10. FIG. 16 shows the configuration of the MFC unit 10 installed in a lake, a river, or the like. FIG. 16 shows a placement example of the MFC unit 10. FIG. 16 shows a sixth MFC unit 10f as an example of the MFC unit 10.

The sixth MFC unit 10f includes an anode electrode 11, a cathode electrode 13, a second gas container 20b, and a coupling circuit 30. A second gas container 20b is an example of the gas container 20. The anode electrode 11, the cathode electrode 13, and the coupling circuit 30 provided in the sixth MFC unit 10f have the same configurations as the anode electrode 11, the cathode electrode 13, and the coupling circuit 30 provided in the first MFC unit 10a, respectively. In the sixth MFC unit 10f shown in FIG. 16, the anode electrode 11 and the cathode electrode 13 are immersed in lake water W.

The second gas container 20b includes a sealing member 27. The second gas container 20b can be disposed in the lake water W. The second gas container 20b is provided, and thereby, the cathode electrode 13 can be placed in the lower part of the lake water W. Further, the second gas container 20b is provided, and thereby, oxygen can be supplied to the oxygen-permeable surface S2 of the cathode electrode 13. The sixth MFC unit 10f can purify the lake water W in the lower part.

FIG. 17 shows a schematic configuration of the MFC unit 10. FIG. 17 shows the configuration of the MFC unit 10 installed in a lake, a river, or the like. FIG. 17 shows a placement example of the MFC unit 10. FIG. 17 shows a placement example of a sixth MFC unit 10f as an example of the MFC unit 10.

An anode electrode 11 and a cathode electrode 13 provided in the sixth MFC unit 10f are disposed in a bottom mud layer ML. An ion exchange surface S1 of the cathode electrode 13 is disposed to face the anode electrode 11. In the bottom mud layer ML, electrochemically active bacteria decompose organic substances contained in organic mud to generate electrons and hydrogen ions. The anode electrode 11 recovers electrons generated by the electrochemically active bacteria. The anode electrode 11 recovers electrons, and thereby, decomposition of the organic substances by the electrochemically active bacteria is continuously performed. The sixth MFC unit 10f can purify lake water W by decomposing the organic substances contained in the bottom mud layer ML.

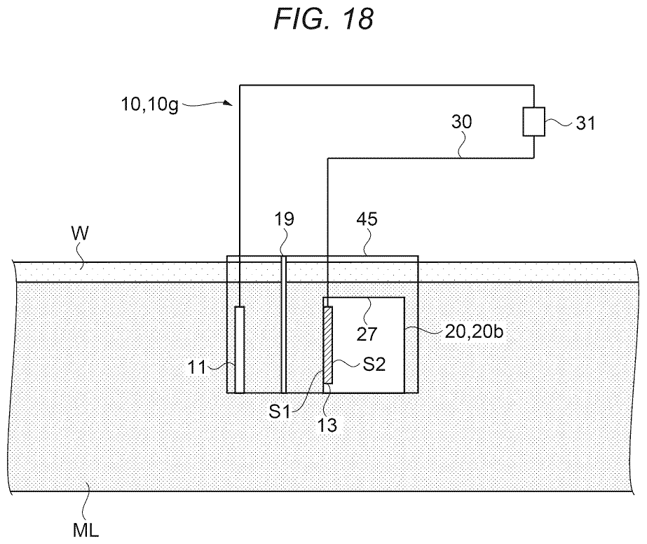

FIG. 18 shows a schematic configuration of the MFC unit 10. FIG. 18 shows the configuration of the MFC unit 10 disposed in a lake, a river, or the like. FIG. 18 shows a placement example of the MFC unit 10. FIG. 18 shows a seventh MFC unit 10g as an example of the MFC unit 10.

The seventh MFC unit 10g includes an anode electrode 11, a cathode electrode 13, an ion exchange membrane 19, a second gas container 20b, a coupling circuit 30, and a supporting casing 45. The anode electrode 11, the cathode electrode 13, the second gas container 20b, and the coupling circuit 30 provided in the seventh MFC unit 10g have the same configurations as the anode electrode 11, the cathode electrode 13, the second gas container 20b, and the coupling circuit 30 provided in the sixth MFC unit 10f, respectively.

The anode electrode 11 and the cathode electrode 13 provided in the seventh MFC unit 10g are disposed in a bottom mud layer ML. An ion exchange surface S1 of the cathode electrode 13 is disposed to face the anode electrode 11. The anode electrode 11 recovers electrons generated by electrochemically active bacteria.

The second gas container 20b includes a sealing member 27. The sealing member 27 prevents organic mud from entering the second gas container 20b. The second gas container 20b and the cathode electrode 13 attached to the second gas container 20b are disposed in the bottom mud layer ML.

The ion exchange membrane 19 allows hydrogen ions generated when the electrochemically active bacteria decompose the organic substances to permeate. The ion exchange membrane 19 has a function of moving hydrogen ions from the anode electrode 11 to the cathode electrode 13. The ion exchange membrane 19 is disposed between the anode electrode 11 and the cathode electrode 13.

The ion exchange membrane 19 is formed using, for example, an ion exchange resin. The ion exchange resin includes NAFION manufactured by DuPont Kabushiki Kaisha, FLEMION manufactured by AGC Inc., and SELEMION manufactured by AGC Inc. NAFION, FLEMION, and SELEMION are registered trademarks. The ion exchange membrane 19 may include a porous membrane having pores permeated by hydrogen ions. The ion exchange membrane 19 includes a porous sheet, a woven fabric sheet, and a nonwoven fabric sheet.

The supporting casing 45 supports the anode electrode 11 and the second gas container 20b. The supporting casing 45 may support the ion exchange membrane 19. The supporting casing 45 supports the cathode electrode 13 by supporting the second gas container 20b. The supporting casing 45 supports the anode electrode 11 and the cathode electrode 13, and thereby, the relative position between the anode electrode 11 and the cathode electrode 13 is fixed. The purification function of lake water W by the seventh MFC unit 10g is stabilized. The supporting casing 45 corresponds to an example of the supporting member.

The supporting casing 45 shown in FIG. 18 supports the anode electrode 11 and the cathode electrode 13 in a bottom mud layer ML, but is not limited thereto. The supporting casing 45 may support the anode electrode 11 and the cathode electrode 13 in the lake water W. The supporting casing 45 can place the anode electrode 11 and the cathode electrode 13 in the lake water W or in a bottom mud layer ML.

The configuration of the supporting casing 45 is not limited as long as the anode electrode 11 and the cathode electrode 13 can be supported. The supporting casing 45 may be formed using a mesh material that allows the lake water W to permeate and prevents organic mud from entering. Since the supporting casing 45 is configured such that the organic mud is less likely to enter, positional variations, deformation, and the like of the anode electrode 11 and the like due to pressure of the organic mud can be suppressed.

The supporting casing 45 preferably supports the anode electrode 11.

Since the supporting casing 45 supports the anode electrode 11, the purification function of the lake water W by the seventh MFC unit 10g is stabilized.

What is claimed is:

1. A water purification apparatus comprising:
a container body holding a liquid containing organic substances and electrochemically active bacteria;
an anode electrode disposed in the liquid;
a hollow body holding a gas containing oxygen;
a cathode electrode having a first surface in contact with the liquid and a second surface that allows the oxygen contained in the gas held in the hollow body to permeate, and being disposed with respect to the anode electrode via the liquid; and
a resistor electrically coupled to the anode electrode and the cathode electrode.

2. The water purification apparatus according to claim 1, wherein
a surface area of a contact surface of the anode electrode in contact with the liquid is larger than a surface area of the first surface of the cathode electrode.

3. The water purification apparatus according to claim 1, wherein
the hollow body is a tubular body having a first opening and a second opening, and
the cathode electrode is attached to the first opening and covers the first opening.

4. The water purification apparatus according to claim 3, wherein
the hollow body includes a lid member that seals the second opening.

5. The water purification apparatus according to claim 4, wherein
the anode electrode is disposed along a bottom surface of the container body, and
the first surface of the cathode electrode is provided in a position facing the anode electrode.

6. The water purification apparatus according to claim 1, further comprising a supporting member that places the cathode electrode in the liquid.

7. A water purification system installed in a liquid containing organic mud and electrochemically active bacteria, comprising:
an anode electrode disposed in the liquid;
a hollow body holding a gas containing oxygen;
a cathode electrode having a first surface in contact with the liquid and a second surface that allows the oxygen contained in the gas held in the hollow body to permeate, and being disposed with respect to the anode electrode via the liquid; and
a resistor electrically coupled to the anode electrode and the cathode electrode.

8. The water purification system according to claim 7, further comprising a supporting member that places the cathode electrode in the liquid.

9. The water purification system according to claim 8, wherein
the supporting member supports the anode electrode.

10. The water purification system according to claim 7, wherein
an organic mud layer in which the organic mud is layered is formed in the liquid,
the anode electrode is disposed in the organic mud layer, and
the first surface of the cathode electrode is disposed to face the anode electrode.
